(19) United States
(12) Patent Application Publication
(10) Pub. No.: US 2003/0152092 A1
(43) Pub. Date: Aug. 14, 2003

(54) Multilevel hierarchical addressing and routing mechanism for high-speed internet

(76) Inventor: Kai Lu, Corvallis, OR (US)

Correspondence Address: Kai Lu, 3806 NW Jameson Dr., Corvallis, OR, 97330, US

(21) Appl. No.: 10/074,808

(22) Filed: Feb. 14, 2002

(51) Int. Cl. H04L 12/56

(52) U.S. Cl. 370/408; 370/392

(57) ABSTRACT

A multilevel hierarchical addressing and routing mechanism for high-speed Internet is presented. The presented mechanism enables an Internet router to make its packet forwarding decision based on a short, fixed-length block of the IP address. This short, fixed-length block can be used as an index to an entry in the routing table. This will significantly speed up the packet forwarding and routing procedure, which is crucial for the future high-speed Internet.

The data transfer speed of the Internet is getting higher and higher. To be able to forward packets at the line speed, a fast packet-forwarding technique is essential for the future high-speed Internet routers. The presented mechanism will enable the future high-speed Internet routers to forward packets at the increasing line speed.

The Internet can be logically viewed as a multilevel hierarchical network. Based on a multilevel view of the Internet, the IP address can be grouped into short, fixed-length blocks. On top of a multilevel view of the Internet and the corresponding grouping of the IP address, a multilevel hierarchical routing mechanism is developed. Using this hierarchical routing mechanism, a router can make its packet forwarding decision based on a short, fixed-length block of the IP address, not the whole IP address. This short, fixed-length block of an IP address can be used as an index to an entry in the routing table. Therefore, the presented mechanism will significantly reduce the packet forwarding time.

Institutions may change their ISPs from time to time. After switching to a new ISP, an institution will get new IP addresses from the new ISP. But this institution may prefer to keep its old IP addresses for its hosts. In this case, an address translator at the edge of the institution's network can be implemented to translate between the corresponding old and new IP addresses for this institution.

The presented mechanism is simple and straightforward, so that it can be implemented using hardware. The hardware implementation will further speed up the address-lookup procedure. Finally, the present invention does not require any topology or connection change to the current Internet.

### FIELD OF THE INVENTION

This invention relates generally to the field of high-speed Internet or high-speed Internet routing, and more particularly to the field of fast address lookup or high-speed packet forwarding on the Internet.

### BACKGROUND OF THE INVENTION

The Internet is the most popular computer network in the world. We use the Internet to send and receive emails, read news, play games, book airline tickets, etc. More and more applications are added to the Internet every day. Using the Internet has become part of our daily life.

The Internet has expanded dramatically in recent years, and it will continue to advance in several dimensions, most notably in the data transfer speed. To handle the rapid growth of Internet traffic, links of several gigabits per second have been deployed on the Internet backbone. Routers connecting these backbone links need to forward millions of packets per second on each of their ports. Therefore, the fast packet forwarding is critical to the future high-speed Internet.

Each packet has a source IP (Internet Protocol) address and a destination IP address. Each router has a routing table. In this routing table, there is an entry for each destination address to tell which port to forward for the packets destined to this address. In order to forward a packet to the correct port, a router needs to look up the packet's destination address and find the matching entry in its routing table. This procedure is called address lookup. Address lookup is a time consuming process. To be able to forward packets at the line speed, fast address lookup is crucial for the future high-speed Internet.

The IP addresses in IP version 4 (IPv4) are 32-bit long, which are divided into 4 classes:

| Class A: | | | |
|---|---|---|---|
| | 0 | Network (7) | Host (24) |

| | | | |
|---|---|---|---|
| Class B: | | | |
| | 10 | Network (14) | Host (16) |

| | | | |
|---|---|---|---|
| Class C: | | | |
| | 110 | Network (21) | Host (8) |

| | | |
|---|---|---|
| Class D: | | |
| | 1110 | Multicast Address (28) |

Class A addresses start with a 0 followed by 7 bits of Network Address and then 24 bits of Host address. Class B addresses start with 10 followed by 14 bits of Network Address and then 16 bits of Host address. Class C addresses start with 110 followed by 21 bits of Network Address and then 8 bits of Host address. Class D addresses start with 1110 and followed by 28 bits of Multicast Address.

It's obvious that the 32-bit address space is not efficiently used in the above classful address assignment. To use this 32-bit address space more efficiently, Internet Engineering Task Force (IETF) developed another addressing scheme called classless interdomain routing (CIDR) [1]. CIDR introduced two ideas:

1. Allow the Network Address part of an IP address to be of any length.

2. Use aggregation to reduce the size of the routing table in a router. Because of these two ideas introduced by CIDR, now an IP address could match more than one entry in a routing table. To find the correct destination for a packet, the router has to find the longest match for its IP address. The longest match made address lookup harder and slower because now we need to consider both the length and the value of the IP address. Reference [2] gives detailed analysis of typical address-lookup algorithms.

The IP addresses in IP version 6 (IPv6) are 128-bit long [3][4], which are 3 times longer than those in IPv4. If we still use the longest match, the address-lookup time will be significantly longer than that in IPv4,so that the address lookup will be the bottleneck in the packet forwarding procedure. Therefore, a fast address-lookup mechanism is essential for the future high-speed Internet.

The key to the fast address lookup is allowing a router to make its packet forwarding decision based on a short, fixed-length number because this short, fixed-length number can be used as an index to the correct entry in the routing table.

In today's Internet, there are two facts related to the address lookup:

1. The IP address is too long to be used as an index to an entry in the routing table.

2. The longest match address lookup is a time consuming process. These two facts prevent a router from making its packet forwarding decision based on a short, fixed-length number. The present invention provides a new mechanism that enables a router to make its packet forwarding decision based on a short, fixed-length number, which is crucial for the future high-speed Internet.

### BACKGROUND—DISCUSSION OF PRIOR ART

There is 1 U.S. patent related to address lookup and Internet. U.S. Pat. No. 6,266,692: Method for blocking all unwanted e-mail (SPAM) using a header-based password, issued Jul. 24, 2001; this invention provides a method for blocking and/or filtering electronic mail. There is 1 U.S. patent related to packet forwarding and Internet. U.S. Pat. No. 6,055,561: Mapping of routing traffic to switching networks, issued Apr. 25, 2000; this invention describes a way to map IP routing information onto a technology that uses label switching and swapping, such as ATM, without the need to change the network paradigm. No U.S. patent is related to multilevel routing or hierarchical routing.

None of the patents above is intended to group the IP address into short, fixed-length blocks according to a multilevel view of the Internet and make a packet forwarding decision based on a short, fixed-length block of the IP address. My invention is different from all the patents above because my invention is not related to label switching or blocking emails. My invention is intended to provide a simple way to speed up the packet forwarding procedure for the future high-speed Internet.

### OBJECTS AND ADVANTAGES

Accordingly, the major object and advantage of the present invention is to provide a simple and fast address-lookup mechanism for high-speed Internet routers to forward packets at the line speed. The mechanism enables an Internet router to make its packet forwarding decision based on a short, fixed-length number. Another advantage is that no topology or connection change is required to the current Internet.

### DESCRIPTION OF THE DRAWINGS

FIG. 1 illustrates a multilevel hierarchical view of the Internet. It is for illustration purpose only and is not a complete picture of the Internet. The dotted lines indicate the ignored parts of the Internet.

FIG. 2 shows a sample network.

FIG. 3 shows a multilevel view of the sample network.

FIG. 4 shows the multilevel view of the sample network with address assignments to the routers.

### SUMMARY

In accordance with the present invention, a multilevel hierarchical addressing and routing mechanism for high-speed Internet is provided.

The traffic over the Internet has been increased dramatically in recent years and will continue to grow in the future. To handle the rapid growth of Internet traffic, links of several gigabits per second has been deployed on the Internet backbone. Routers connecting these backbone links need to forward millions of packets per second on each of their ports. In order to forward a packet to the right port, the router needs to analyze the packet's destination address and find the matching entry in its routing table. This procedure is called address lookup. Address lookup is a time consuming procedure. In the future high-speed Internet, fast address lookup is essential for a router to catch up with the increasing line speed.

The key to the fast address lookup is allowing a router to make its packet forwarding decision based on a short, fixed-length number because this short, fixed-length number can be used as an index to the correct entry in the routing table.

The longest match in address lookup is one of the problems in today's Internet. With the longest match, we have to consider both the length and the value of the IP address. The longest match significantly slows down the address-lookup procedure. To speed up the address lookup, we need to eliminate the longest match and use a short, fixed-length match.

Another issue in today's Internet is the long IP address. In IPv4, the IP address is 32-bit long and in IPv6, the IP address is 128-bit long. In today's Internet, a router considers an IP address as a whole. The whole IP address is too long to be used as an index to the correct entry in the routing table. But a router doesn't have to use the whole IP address to make its packet forwarding decision. Our goal is not to use the IP address as a whole, but to use one short, fixed-length block at a time. So this short, fixed-length block can be used as an index to the correct entry in the routing table.

In summary, the key to fast address lookup is eliminating the longest match and using a short, fixed-length block of an IP address as an index to an entry in the routing table.

The Internet is getting larger and larger every day. As the Internet gets larger, we need longer IP addresses to address each device attached to the Internet. Therefore, longer IP addresses are not avoidable in the future Internet. But a particular router does not need the whole IP address to make its packet forwarding decision. It is possible to organize the IP address into short, fixed-length blocks, and a particular router should be able to make its packet forwarding decision only based on certain blocks of an IP address, not the whole IP address.

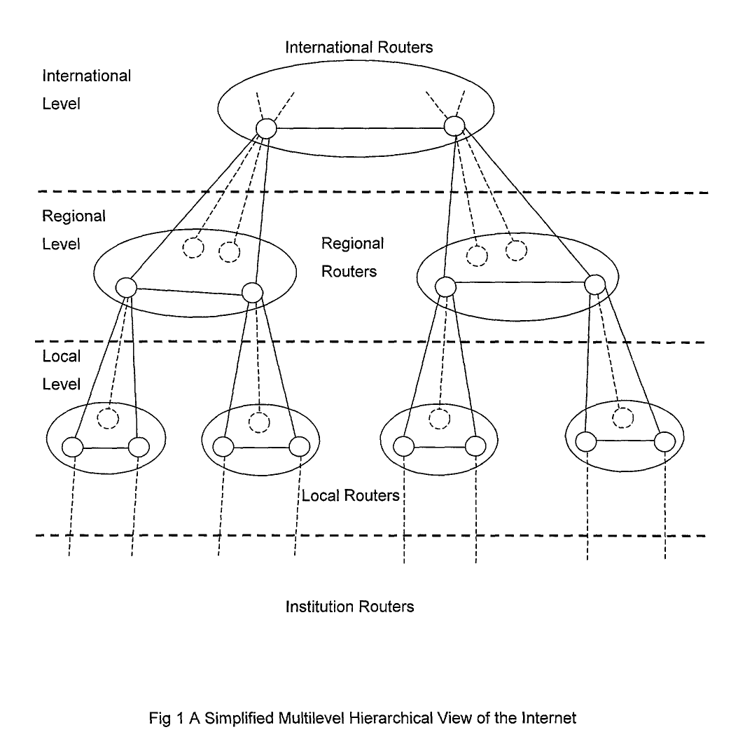

But based on which block of the IP address can a particular router make its packet forwarding decision? The answer to this question depends on how we logically view the structure of the Internet and how we organize the IP address accordingly. The current Internet routers can be logically organized into multiple levels. For example, FIG. 1 illustrates a simplified logical view of the Internet as a multilevel hierarchical network. From top to bottom, we call the first level the International Level; routers at this level are called the international routers. We call the second level the Regional Level; routers at this level are called regional routers. And again we call the third level the Local Level; routers at this level are called local routers. Finally, routers below the local routers are called institution routers.

This is just a logical view of the Internet. We do not need to change the physical connections of the current Internet. The Internet can be viewed as another logical structure.

Note that a particular router could belong to two levels. For example, a router could belong to both the International level and the Regional level, and another router could belong to both the Regional level and the Local level. In this case, that router should be split into two, and put one in each level.

Is it possible to view the Internet as a multilevel network? The answer is yes. Any network can be logically viewed as a multilevel network. One way of organizing a general network into a multilevel network is as follows:

1. Based on the network's topology and how many levels we want to create, pick a connected group of routers and assign this group of routers to the first level.

2. Among the rest of the routers, those directly connected to a router in the first level belong to the second level. Based on the topology of the network and how many levels we want to create, the second level can further include more routers that are directly connected to a router that is already in the second level.

3. Among the rest of the routers, those directly connected to a router in the second level belong to the third level. Based on the topology of the network and how many levels we want to create, the third level can further include more routers that are directly connected to a router that is already in the third level.

4. Continue this procedure until no more routers are left.

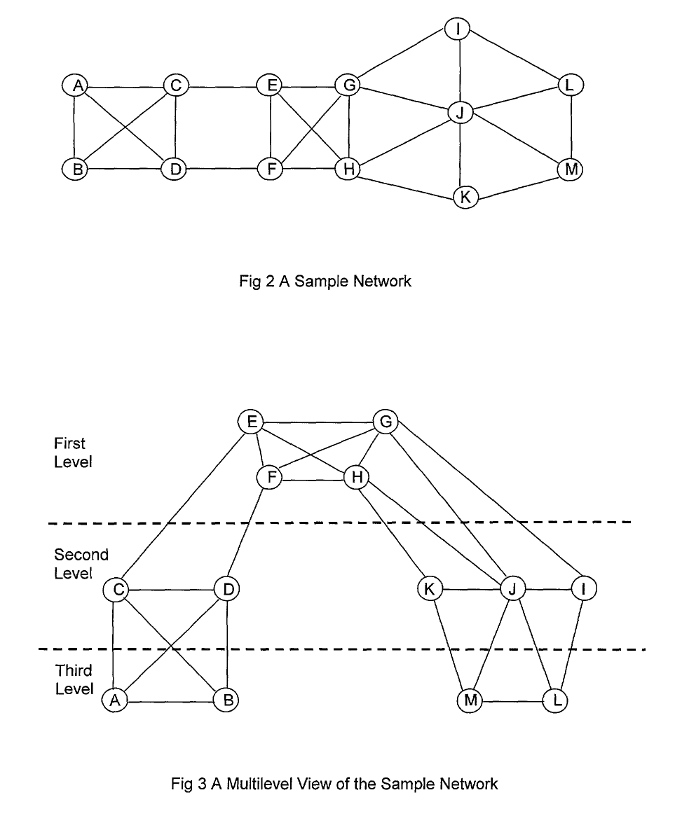

For example, a general network as shown in FIG. 2 can be viewed as a three-level network as shown in FIG. 3. In this example, routers E, F, G and H are assigned the role of the first level router. Routers C, D, K, J and I are assigned the role of the second level router, and routers A, B, M and L are assigned the role of the third level router.

The goal of viewing the Internet as a multilevel network is to enable a router in a particular level to make its packet forwarding decision only based on a particular block of the IP address, not the whole IP address. To achieve this goal, we need to group the IP address into blocks according to the multilevel view of the Internet. There are many ways to view the Internet as a multilevel network. A different view of the Internet will need a different IP address grouping.

Based on the above multilevel view of the Internet as show in FIG. 1, the IP address should be grouped into five blocks as follows:

| | | | | |
|---|---|---|---|---|
| International | Regional | Local | Institution | Interface |
| Address | Address | Address | Address | Number |

From left to right, the first block is corresponding to the first level of the multilevel view of the Internet, called the International Address (first level address). The second block is corresponding to the second level of the multilevel view of the Internet, called the Regional Address (second level address), and so on. The last block is the Interface Number.

Each International Router has one International Address; we assign an International Address to each International Router based on the topology of the Internet. Each Regional Router has one International Address and one Regional Address; we assign a Regional Address to each Regional Router based on the topology of the Internet; if a Regional Router is directly connected to an International Router, this Regional Router will inherit the International Address from the connected International Router; otherwise, this Regional Router will share the same International Address with its neighbor Regional Router. Each Local Router has one International Address, one Regional Address and one Local Address; we assign a Local Address to each Local Router based on the topology of the Internet; if a Local Router is directly connected to a Regional Router, this Local Router will inherit both the International Address and the Regional Address from the connected Regional Router; otherwise, this Local Router will share the same International Address and Regional Address with its neighbor Local Router. Similarly, each Institution Router will have one International Address, one Regional Address, one Local Address and one Institution Address.

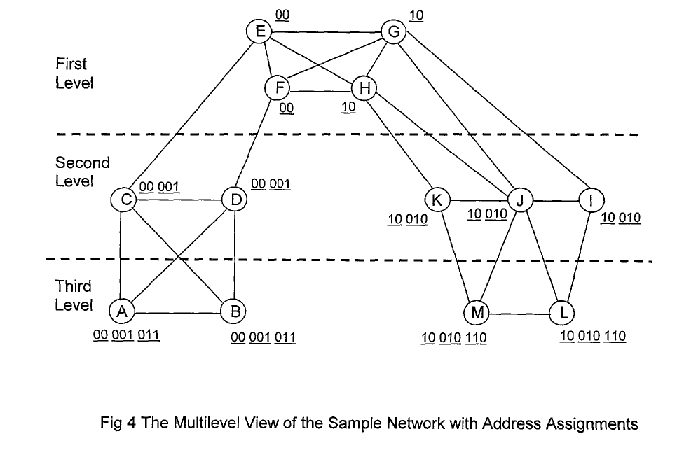

For example, in our sample network, we assign the first level address: 00 to the first level routers: E and F, and assign the first level address: 10 to the first level routers: G and H. Second level routers C and D inherit the first level address 00 from the first level routers E and F. We assign the second level address: 001 to the second level routers C and D. Second level routers K, J and I inherit the first level address 10 from the first level routers G and H. We assign the second level address: 010 to the second level routers K, J and I. Similarly the third level routers A and B will get first level address: 00, second level address: 001 and third level address: 011, and the third level routers M and L will get first level address: 10, second level address: 010 and third level address: 110, as shown in FIG. 4.

Now, each block of the IP address is a short and fixed-length number. A particular router can make its packet forwarding decision only based on some blocks of the IP address, not the whole IP address. This will make the address lookup and packet forwarding procedure much simpler and faster because a router can use this short, fixed-length number as an index to the correct entry in its routing table.

Based on which block of the IP address can a router make its packet forwarding decision? This will depend on which level the router belongs to. At the International level, after receiving a packet, an international router can make its packet forwarding decision as follows in order:

1. If the International Address block of the packet's destination address matches the router's International Address, the router will forward this packet one level down to the proper Regional Router based on the Regional Address block of the packet's destination address and skip step 2.

2. If the International Address block of the packet's destination address doesn't match the router's International Address, the router will forward this packet to the proper router based on the International Address block of the packet's destination address.

At the Regional level, after receiving a packet, a Regional Router will do the following in order:

1. If the International Address block of the packet's destination address doesn't match the router's International Address, the router will forward this packet one level up to the proper International Router based on the International Address block of the packet's destination address and skip steps 2 and 3.

2. If the Regional Address block of the packet's destination address matches the router's Regional Address, the router will forward this packet one level down to the proper Local Router based on the Local Address block of the packet's destination address and skip step 3.

3. If the Regional Address block of the packet's destination address doesn't match the router's Regional Address, the router will forward this packet to the proper router based on the Regional Address block of the packet's destination address.

Similarly at the Local level, after receiving a packet, a Local Router will do the following in order:

1. If the International Address block of the packet's destination address doesn't match the router's International Address or the Regional Address block of the packet's destination address doesn't match the router's Regional Address, the router will forward this packet one level up to a Regional Router and skip steps 2 and 3.

2. If the Local Address block of the packet's destination address matches the router's Local Address, the router will forward this packet down to the proper institution router based on the Institution Address block of the packet's destination address and skip step 3.

3. If the Local Address block of the packet's destination address doesn't match the router's Local Address, the router will forward this packet to the proper router based on the Local Address block of the packet's destination address.

Now, a router can make a packet forwarding decision based on a block of the IP address, which is a short, fixed-length number. This allows the router to use this short, fixed-length number as an index to the correct entry in the routing table. Therefore, the address-lookup time will be significantly reduced.

It is obvious that the logical view of the Internet and the IP address assignment is based on the geographical location of the Internet Service Providers (ISP) and institutions. However, it's common that an institution wants to switch to another ISP without changing the IP addresses of its hosts. The ideal solution should allow this institution to keep its old IP addresses for its hosts and do not require routers to remember that this institution has changed its ISP.

This goal can be achieved using the following mechanism:

1. After switching to a new ISP, an institution is allowed to keep its old IP addresses for its hosts.

2. The new ISP will assign a new set of IP addresses to this institution.

3. Implement an address translator at the edge of the institution's network to translate between the corresponding old and new IP addresses.

4. All the packets coming in and going out of the institution will go through this address translator. For all the outgoing packets, the address translator will change the source address to the corresponding new IP address. For all the incoming packets, the address translator will change the destination address to the corresponding old IP address.

The new ISP thinks that this institution has switched to the new IP addresses just assigned to it. So the new ISP starts advertising the new set of IP addresses and forwarding all packets destined to the new IP addresses to this institution. The old ISP thinks that this institution has released the old IP addresses. So the old ISP starts assigning the old IP addresses to another institution.

In fact, this institution is using both new and old IP addresses. Inside the institution, it still uses the old set of IP addresses for its hosts. Outside the institution, it is known by the new set of IP addresses. The address translation and swapping are done by the address translator at the edge of the institution's network.

Note that the old set of IP addresses is not wasted. The old ISP can safely assign the old set of IP addresses to another institution.

The multilevel addressing and routing mechanism described above works with long IP addresses, which are not avoidable for the future Internet. At the same time it enables a router to make its packet forwarding decision based on a short, fixed-length number. This short, fixed-length number can be used as an index to the correct entry in the routing table. This will significantly speed up the address-lookup procedure, which is essential for the future high-speed Internet.

The presented multilevel addressing and routing mechanism does not need the longest address match or complicated address-lookup algorithms, which are time consuming.

The mechanism described above is simple and straightforward so that it can be implemented using hardware. The hardware implementation will further speed up the address lookup and routing procedure. Finally this multilevel addressing and routing mechanism does not require any topology or connection change to the current Internet.

### CONCLUSION, RAMIFICATIONS, AND SCOPE OF INVENTION

Thus, those skilled in the art will appreciate that the present invention provides a simple and fast address-lookup mechanism for the future high-speed Internet. This mechanism enables a router to make its packet forwarding decision based on a short, fixed-length number. This short, fixed-length number can be used as an index to the correct entry in the routing table. This will simplify and speed up the address-lookup procedure dramatically. The fast address-lookup technique for future Internet routers is badly needed since the data transfer speed of the Internet links is getting higher and higher.

By viewing the Internet as a multilevel hierarchical network and organizing the IP address into short, fixed-length blocks accordingly, an Internet router can make its packet forwarding decision based on a block of the IP address, not the whole IP address. That means a router can make its packet forwarding decision based on a short, fixed-length number. This will significantly reduce the address-lookup time because this short, fixed-length number can be used as an index to the correct entry in the routing table.

By introducing an address translator at the edge of an institution's network, the institution can keep its old IP addresses for its hosts after switching to a new ISP. This is convenient to and desirable by all institutions. The old IP addresses are not wasted. They can be reassigned to another institution.

The presented mechanism is simple and straightforward, so that it can be implemented using hardware. The hardware implementation can further speed up the address-lookup procedure, which will enable the future Internet routers to catch up to the increasing line speed.

The mechanism described above only logically views the Internet as a multilevel hierarchical network. It does not require any topology or connection change to the current Internet.

While my description above contains specificities, these should not be construed as limitations on the scope of the invention, but rather as an exemplification of one preferred embodiment thereof. Many other variations are possible. For example, the Internet can be viewed as a 2-level or 5-level network.

Accordingly, the scope of the invention should be determined not by embodiment illustrated, but by the appended claims and their legal equivalents.

### REFERENCES

[1] V. Fuller, T. Li, J. Yu, K. Varadhan “Classless Inter-Domain Routing (CIDR): an Address Assignment and Aggregation Strategy” http://www.rfc.net/rfc1519.txt, September 1993.

[2] Miguel A. Ruiz-Sanchez, Ernst W. Biersack, Walid Dabbous “Survey and Taxonomy of IP Address Lookup Algorithms” IEEE Network March/April 2001 Vol. 15 No. 2, pp 8-23

[3] R. Hinden, S. Deering “IP Version 6 Addressing Architecture” http://www.rfc.net/rfc2373.html, July 1998.

[4] R. Hinden, M. O'Dell, S. Deering, “An IPv6 Aggregatable Global Unicast Address Format” http://www.rfc.net/rfc2374.html, July 1998.

I claim:

1. A multilevel hierarchical addressing and routing mechanism for high-speed Internet; the mechanism comprising:
A multilevel hierarchical view of the Internet, which is the base for grouping the IP address into short, fixed-length blocks;
A grouping of the IP address into short, fixed-length blocks based on the multilevel hierarchical view of the Internet, so that a short, fixed-length block of the IP address can be used as an index to an entry in the routing table;
An address assignment to all Internet routers based on the multilevel hierarchical view of the Internet;
A hierarchical method for an Internet router to make its packet forwarding decision based on a block of the IP address; and
An address translator at the edge of an institution's network to translate between new and old ip addresses after this institution switched to a new ISP and got a new set of IP addresses from the new ISP.

2. The mechanism of claim 1, wherein said the multilevel hierarchical view of the Internet can be created as follows:
a. Pick a connected group of Internet routers and assign them to the first level, called the first level routers. The number of routers at the first level depends on the Internet topology and how many levels we want to create.
b. Among the rest of the routers, those directly connected to one of the first level routers belong to the second level, called the second level routers. Depending on the Internet topology and how many levels we want to create, the second level can further include some routers that are directly connected to a router that is already in the second level.
c. Similarly, among the rest of the routers, those directly connected to one of the second level routers belong to the third level, called the third level routers. And again depending on the Internet topology and how many levels we want to create, the third level can further include some routers that are directly connected to a router that is already in the third level.
d. Continue this procedure until no more routers are left.

3. The mechanism of claim 1, wherein said the grouping of the IP address into short, fixed-length blocks based on the multilevel hierarchical view of the Internet can be done as follows. If there are n levels in said the multilevel hierarchical view of the Internet, we will group the IP address into n+1 blocks. From left to right, the first block is corresponding to the first level of said the multilevel hierarchical view of the Internet, called the first level address. The second block is corresponding to the second level of said the multilevel hierarchical view of the Internet, called the second level address, and so on. The last block is called the interface number. The length of each block is chosen based on the number of routers in the corresponding level of said the multilevel hierarchical view of the Internet and the potential growth of that level.

4. The mechanism of claim 1, wherein said the address assignment to all Internet routers based on the multilevel hierarchical view of the Internet can be done as follows:
a. Each said first level router has one said first level address; we assign a said first level address to each said first level router based on the topology of the Internet.
b. Each said second level router has one said first level address and one said second level address; we assign a said second level address to each said second level router based on the topology of the Internet; if a said second level router is directly connected to a said first level router, this said second level router will inherit the said first level address from the connected said first level router; otherwise, this said second level router will share the same said first level address with its neighbor said second level router.
c. Each said third level router has one said first level address, one said second level address and one said third level address; we assign a said third level address to each said third level router based on the topology of the Internet; if a said third level router is directly connected to a said second level router, this said third level router will inherit both the said first level address and the said second level address from the connected said second level router; otherwise, this said third level router will share the same said first level address and the same said second level address with its neighbor said third level router.
d. Similarly, we can assign addresses for fourth level routers, fifth level routers, and so on.

5. The mechanism of claim 1, wherein said the hierarchical method for an Internet router to make its packet forwarding decision can be implemented as follows.
At said the first level, after receiving a packet a said first level router will do the following in order:
a. If said the First Level Address block of the packet's destination address matches the router's said First Level Address, the router will forward this packet one level down to the proper said second level router based on said the Second Level Address block of the packet's destination address and skip step b.
b. If said the First Level Address block of the packet's destination address doesn't match the router's said First Level Address, the router will forward this packet to the proper router based on said the First Level Address block of the packet's destination address.
At said the second level, after receiving a packet a said second level router will do the following in order:
a. If said the First Level Address block of the packet's destination address doesn't match the router's said First Level Address, the router will forward this packet one level up to the proper said First Level router based on said the First Level Address block of the packet's destination address and skip steps b and c.
b. If said the Second Level Address block of the packet's destination address matches the router's said Second Level Address, the router will forward this packet one level down to the proper said third level router based on said the Third Level Address block of the packet's destination address and skip step c.
c. If said the Second Level Address block of the packet's destination address doesn't match the router's said Second Level Address, the router will forward this packet to the proper router based on said the Second Level Address block of the packet's destination address.
At said the third level, after receiving a packet a said third level router will do the following in order:
a. If said the First Level Address block of the packet's destination address doesn't match the router's said First Level Address or said the Second Level Address block of the packet's destination address doesn't match the router's said Second Level Address, the router will forward this packet one level up to a said second level router and skip steps b and c.
b. If said the Third Level Address block of the packet's destination address matches the router's said Third Level Address, the router will forward this packet one level down to the proper said fourth level router based on the said Fourth Level Address block of the packet's destination address and skip step c.
c. If said the Third Level Address block of the packet's destination address doesn't match the router's said Third Level Address, the router will forward this packet to the proper router based on the said Third Level Address block of the packet's destination address.
Similarly we can define the packet forwarding rules for routers at the fourth level, fifth level, and so on.

6. The mechanism of claim 1, wherein said the address translator at the edge of an institution's network can be implemented as follows. After switching to a new ISP, an institution can keep its old IP addresses for its hosts, and the new ISP will still assign new IP addresses for this institution. The said address translator will translate all the incoming packet's destination address to the corresponding old IP address from the new one, and translate all the outgoing packet's source address to the corresponding new IP address from the old one.
